(19) United States
(12) Patent Application Publication
(10) Pub. No.: US 2016/0336807 A1
(43) Pub. Date: Nov. 17, 2016

(54) WIRELESS POWER OUTLET AND METHOD OF TRANSFERRING POWER THEREBY

(71) Applicant: POWERMAT TECHNOLOGIES LTD., Neve Ilan (IL)

(72) Inventors: ELIESER MACH, ROSH TZURIM (IL); OZ MOSHKOVICH, REHOVOT (IL); ILYA GLUZMAN, HOLON (IL); OOLA GREENWALD, MEVASSERET ZION (IL); GUY RAVEH, MATAA (IL)

(21) Appl. No.: 15/112,563

(22) PCT Filed: Jan. 19, 2015
(86) PCT No.: PCT/IL2015/050061

§ 371 Date: Jul. 19, 2016

Related U.S. Application Data
(60) Provisional application No. 61/929,064, filed on Jan. 19, 2014.

(51) Int. Cl. H02J 50/12; H02J 50/60; H02J 50/80

(52) U.S. Cl. CPC H02J 50/12; H02J 50/80; H02J 50/60

(57) ABSTRACT

A method of transferring power inductively is provided, the method comprising providing a wireless power outlet comprising a primary inductive coil connected to a power source via a driver, providing a secondary unit configured and disposed to form an inductive couple with the wireless power outlet for power transfer, emitting, by the wireless power outlet, one or more digital pings at a predetermined power level, determining if at least one or more of the digital pings engaged the secondary unit, repeating, if engagement of a secondary unit was not determined to have occurred, the emitting and determining until a digital ping engages a secondary unit, wherein the power of the digital pings is increased relative to the previous emitting, and transferring power from the wireless power outlet to the secondary unit according to a wireless power transfer standard in accordance with the power of the engaged digital ping.

### FIELD OF THE INVENTION

The present disclosure relates to wireless power outlets, and to methods of transferring power thereby.

### BACKGROUND OF THE INVENTION

The use of a wireless non-contact system for the purposes of automatic identification or tracking of items is an increasingly important and popular functionality.

Inductive power coupling allows energy to be transferred from a power supply to an electric load without a wired connection therebetween. An oscillating electric potential is applied across a primary inductor. This sets up an oscillating magnetic field in the vicinity of the primary inductor. The oscillating magnetic field may induce a secondary oscillating electrical potential in a secondary inductor placed close to the primary inductor. In this way, electrical energy may be transmitted from the primary inductor to the secondary inductor by electromagnetic induction without a conductive connection between the inductors.

When electrical energy is transferred from a primary inductor to a secondary inductor, the inductors are said to be inductively coupled. An electric load wired in series with such a secondary inductor may draw energy from the power source wired to the primary inductor when the secondary inductor is inductively coupled thereto.

In order to take advantage of the convenience offered by inductive power coupling, inductive outlets having primary inductors may be installed in different locations that people typically use to rest their devices, such that they may be charged while at rest.

There are several standards for transferring power inductively. Not all standards are designed to be compatible with one another, and attempting to transfer power to a secondary unit according to a standard for which it is not designed may cause damage thereto. This is a particular concern if the standard according to which the attempt is made uses more power than the standard according to which the secondary unit is designed.

### SUMMARY OF THE INVENTION

According to one aspect of the presently disclosed subject matter, there is provided a method of transferring power inductively, the method comprising:
providing a wireless power outlet comprising a primary inductive coil connected to a power source via a driver;
providing a secondary unit configured and disposed to form an inductive couple with the wireless power outlet for power transfer;
emitting, by the wireless power outlet, one or more digital pings at a predetermined power level;
determining if at least one or more of the digital pings engaged the secondary unit;
repeating, if engagement of a secondary unit was not determined to have occurred, the emitting and determining until a digital ping engages a secondary unit, wherein the power of the digital pings is increased relative to the previous emitting; and
transferring power from the wireless power outlet to the secondary unit according to a wireless power transfer standard in accordance with the response received by the wireless power outlet to the engaged digital ping.

The emitting and determining may be repeated no more than one time, the digital pings of the first emitting being at a low-power, and the digital pings of the second emitting being at a high-power.

The transferring may be in accordance with a first standard, such as the Wireless Power Consortium WPC standard for example, if the digital pings at a low-power engaged the secondary unit.

The transferring may be in accordance with a second standard, such as the Powermatters Alliance PMA standard for example, if the digital pings at a high-power engaged the secondary unit.

The method may further comprise, prior to the emitting, detecting, by the wireless power outlet, a possible presence of the secondary unit.

The detecting may comprise emitting, by the inductive outlet, an analog ping.

The digital pings at a low-power may each have a frequency of about 175 kHz.

The digital pings at a low-power may have frequencies selected from the group consisting of about 175 kHz, about 142 kHz, about 140 kHz, about 130 kHz, about 111 kHz, and about 110 kHz.

The digital pings at a low-power may be between about 4V and about 6V.

The digital pings at a high-power may each have a frequency of between 90 and 120 kHz.

The digital pings at a high-power may each have a frequency of about 100 kHz.

The digital pings at a high-power may each have a frequency of about 110 kHz.

The digital pings at a high-power may be between about 8V and about 10V.

The digital pings of each repeated emitting may have a slightly lower frequency that those of the previous emitting. This may occur, for example, when the frequency is above the self-resonant frequency of an inductive couple formed between the wireless power outlet and secondary unit.

The transferring may be according to one of at least two standards.

According to another aspect of the presently disclosed subject matter, there is provided a method of transferring power inductively, the method comprising:
providing a wireless power outlet comprising a primary inductive coil connected to a power source via a driver;
providing a secondary unit configured and disposed to form an inductive couple with the wireless power outlet for power transfer;
emitting, by the wireless power outlet, one or more pulses;
measuring one or more electrical parameters of the primary inductive coil, resulting from said pulses, compared to time;
calculating, based on the measuring, an impedance associated with the secondary unit;
matching, by the wireless power outlet, the calculated impedance to known values of impedances of secondary units, thereby identifying the secondary unit; and
transferring power from the wireless power outlet to the secondary unit, in accordance with a standard associated with the identified secondary unit.

The pulses may be low powered.

The wireless power outlet may be preloaded with data pertaining to specifications of secondary units according to two or more standards.

The standards may comprise one or more of the WPC standard, the PMA standard, and the standard defined in “A4WP Wireless Power Transfer System Baseline System Specification” (hereafter, “A4WP standard”, the full contents of which are incorporated herein by reference; it will be appreciated that the term “A4WP standard” includes any document which subsequently supersedes it).

The wireless power outlet may be configured to request and obtain data pertaining to specifications of secondary unit according to two or more standards.

The method may further comprise, prior to the emitting, detecting, by the wireless power outlet, a possible presence of the secondary unit.

The detecting may comprise emitting, by the inductive outlet, an analog ping.

The electrical parameters may include one or more selected from the group consisting of amplitude of voltage and amplitude of current.

According to a further aspect of the presently disclosed subject matter, there is provided a wireless power outlet comprising a primary inductive coil connected to a power source via a driver, and being configured to transfer power inductively to a secondary unit by:
emitting one or more digital pings at a predetermined power level;
determining if at least one or more of the digital pings engaged a secondary unit;
repeating, if engagement of a secondary unit was not determined to have occurred, the emitting and determining until a digital ping engages a secondary unit, wherein the power of the digital pings is increased relative to the previous emitting; and
transferring power to the secondary unit according to a wireless power transfer standard in accordance with the response received by the wireless power outlet to the engaged digital ping.

The emitting and determining may be repeated no more than one time, the digital pings of the first emitting being at a low-power, the digital pings of the second emitting being at a high-power.

The transferring may be in accordance with a first standard if the digital pings at a low-power engaged a secondary unit.

The transferring may be in accordance with a second standard if the digital pings at a high-power engaged a secondary unit.

The wireless power outlet may further be configured to detect, prior to the emitting, a possible presence of the secondary unit.

The detecting may comprise emitting an analog ping.

The digital pings at a low-power may each have a frequency of about 175 kHz.

The digital pings at a low-power may have frequencies selected from the group consisting of about 175 kHz, about 142 kHz, about 140 kHz, about 130 kHz, about 111 kHz, and about 110 kHz.

The digital pings at a low-power may be between about 4V and about 6V.

The digital pings at a high-power may each have a frequency of about 110 kHz.

The digital pings at a high-power may be between about 8V and about 10V.

The digital pings of each repeated emitting may have a slightly lower frequency that those of the previous emitting. This may occur, for example, when the frequency is above the self-resonant frequency of an inductive couple formed between the wireless power outlet and secondary unit.

The transferring may be according to one of a first standard and a second standard.

According to a still further aspect of the presently disclosed subject matter, there is provided a wireless power outlet comprising a primary inductive coil connected to a power source via a driver, and being configured to transfer power inductively to a secondary unit by:
emitting one or more pulses;
measuring one or more electrical parameters of the primary inductive coil, resulting from said pulses, compared to time;
calculating, based on the measuring, an impedance, inductance or capacitance associated with the secondary unit;
matching the calculated impedance to known values of impedances of secondary units, thereby identifying the secondary unit; and
transferring power to the secondary unit, in accordance with a standard associated with the identified secondary unit.

The pulses may be low powered.

The wireless power outlet may be preloaded with data pertaining to specifications of secondary units according to two or more standards.

The standards may comprise one or both of a first standard and a second standard.

The wireless power outlet may be configured to request and obtain data pertaining to specifications of secondary unit according to two or more standards.

The wireless power outlet may be configured to detect, prior to the emitting, a possible presence of the secondary unit.

The detecting may comprise emitting an analog ping.

The electrical parameters may include one or more selected from the group consisting of amplitude of voltage and amplitude of current.

### BRIEF DESCRIPTION OF THE DRAWINGS

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the several selected embodiments may be put into practice. In the accompanying drawings:

FIG. 1 is a schematic illustration of a wireless power outlet and secondary unit according to the presently disclosed subject matter; and

FIGS. 2 through 4 illustrate methods of transferring power inductively.

### DETAILED DESCRIPTION

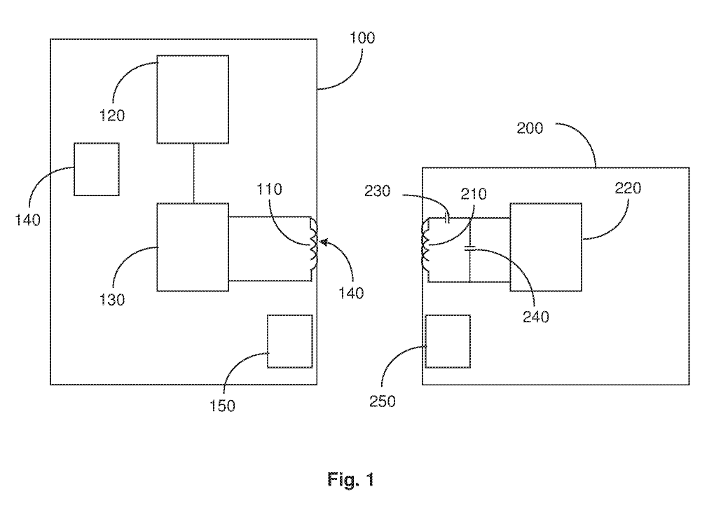

As illustrated in FIG. 1, there is provided a wireless power outlet 100, such as an inductive power outlet, a resonant power outlet, or the like, adapted to transmit power wirelessly to a secondary unit 200 remote therefrom. The wireless power outlet 100 comprises a primary inductive coil 110 connected to a power source 120 via a driver 130. The driver 130 is configured to provide an oscillating driving voltage to the primary inductive coil 110. The wireless power outlet 100 may further comprise a controller 140, such as a microcontroller unit, to direct operation thereof.

It will be appreciated than any action described herein as being performed by the wireless power outlet 100 may be performed, in whole or in part, by the controller 140. It will be further appreciated than any ability described herein (e.g., with “configured to” language) as being possessed by the wireless power outlet 100 may be embodied, in whole or in part, by the controller 140.

The secondary unit 200 comprises a secondary inductive coil 210, wired to an electric load 220, and which is configured to form an inductive couple with the primary inductive coil 110. Formation of such an inductive couple facilitates the electric load 220 to draw power from the power source 120. In addition, the secondary unit 200 may comprise one or both of a series capacitor 230 connected serially between the secondary inductive coil 210 and the electric load, and a parallel capacitor 240 connected in parallel to the secondary inductive coil between it and the electric load. The capacitors 230, 240 may contribute to an impedance of the secondary unit 200.

In addition to the transfer of power, the inductive couple may be used to establish a communication channel between a transmitter 250 associated with the secondary unit 200, and a receiver 150 associated with the wireless power outlet 100. The communication channel may provide feedback signals and/or other relevant information to the driver 130.

The wireless power outlet 100 is configured to monitor a surface 160 near the primary inductive coil 110, in order to determine whether or not a possible a secondary unit 200 has entered within its range. It may accomplish this by any suitable method.

According to one example, the wireless power outlet 100 may perform an “analog ping” to detect the presence of a resonance shift, for example owing to the presence of a (magnetically active) object on or near the surface 160. According to this method, a very short pulse is applied to the primary inductive coil 110 at an operating frequency which corresponds to the resonance frequency of the primary inductive coil and a series resonant capacitance. This current in the primary inductive coil 110 can be measured, and if it is below a predetermined threshold, the wireless power outlet 100 may conclude that an object is present.

According to another example, the wireless power outlet 100 may perform an “analog ping” to detect a change of the capacitance of an electrode (i.e., of a secondary unit 200) on or near the surface 160.

Both of the above methods are known in the art, and are described, inter alia, in “System Description—Wireless Power Transfer, Vol. I: Low Power, Part 1: Interface Definition”, version 1.0.1 published by the Wireless Power Consortium (hereafter, “WPC standard”; it will be appreciated that the term “WPC standard” includes any document which subsequently supersedes it) and dated June 2013 (the full contents of which are incorporated herein by reference), in Annex B thereof. It will be appreciated that the wireless power outlet 100 may be configured to monitor the surface 160 for the presence (or possible presence) of a secondary unit 200 according to any other suitable method, for example including other methods of performing an “analog ping”.

Once the (possible) presence of a secondary unit 200 or near the surface 160 has been detected, e.g., as described above, the wireless power outlet 100 is configured to determine power requirements of the secondary unit 200.

According to one embodiment, the wireless power outlet 100, after the detection (e.g., by an analog ping), initiates one or more digital pings, i.e., power signals which are emitted for the purpose of identifying the type of secondary unit 200 which is present. Each of the pings is designed to cause the secondary unit 200 to transmit a response, typically in the form of one or more packets, which is detected by the wireless power outlet 100.

Initially, the wireless power outlet 100 emits a predetermined number of initial digital pings according to a low-power first standard wireless transfer protocol, for example as defined in the WPC standard. According to some examples, the initial digital pings may have the same frequency, e.g., about 175 kHz. According to other examples, the initial digital pings comprises a set of pings having different frequencies, such as one or more of 175 kHz, 142 kHz, 140 kHz, 130 kHz, 111 kHz, and 110 kHz. The voltages of the initial digital pings may range between 4V and 6V.

If one of the initial digital pings engages the secondary unit 200, i.e., the wireless power outlet 100 receives a suitable response therefrom, e.g., as defined in the WPC standard, the wireless power outlet may proceed to transfer power thereto according to a suitable method, such as the first standard. The method is determined by and is in accordance with the response to the engaged digital ping (e.g., if the response to the initial digital ping indicates a secondary unit conforming to the WPC standard, the method of wireless power transfer thereto will be in accordance with the WPC standard; if the response to the initial digital ping indicates a secondary unit conforming to the PMA standard, the method of wireless power transfer thereto will be in accordance with the PMA standard, etc.) For example, it may identify the secondary unit 200, and obtain configuration information (e.g., the maximum amount of power that it intends to provide at its output) therefrom. The wireless power outlet may use this information to create a power transfer contract, which contains limits for several parameters that characterize the power transfer in the power transfer phase. Subsequently, the wireless power outlet 100 may commence power transfer.

If none of the initial digital pings engages the secondary unit 200, i.e., the wireless power outlet 100 does not receive a suitable response therefrom, the wireless power outlet emits one or more secondary digital pings, which are more energetic than the initial digital pings. The secondary digital pings are configured to cause a secondary unit 200 designed according to a second standard such as the “PMA Inductive Wireless Power Transfer Transmitter Specification” published by the Power Matters Alliance, the full contents of which are incorporated herein by reference (hereafter, “PMA standard”; it will be appreciated that the term “PMA standard” includes any document which subsequently supersedes it), to transmit a response, typically in the form of one or more packets, which is detected by the wireless power outlet 100.

According to different examples, the secondary digital pings may have a frequency which is between 90 kHz and 120 kHz possibly above about 110 kHz. The secondary digital pings have a voltage in the range between 8V and 10V.

If one of the secondary digital pings engages the secondary unit 200, i.e., the wireless power outlet 100 receives a suitable response therefrom, e.g., as defined in the PMA standard, the wireless power outlet may proceed to transfer power thereto according to a suitable method, e.g., the PMA standard. For example, it may identify the secondary unit 200, verify that it is a compliant device, and commence power transfer.

According to another embodiment, the wireless power outlet 100, after the detection (e.g., by an analog ping), initiates a sliding ping procedure, in which initially, the wireless power outlet emits low-energy digital pings. If no response is received from the secondary unit 200, the wireless power outlet 100 gradually reduces the frequency of subsequent pings, thereby increasing their energy.

Once the wireless power outlet 100 receives a response from the secondary unit 200, it attempts to identify its type (for example, using identification according to the WPC standard and/or the PMA standard, as appropriate) and proceeds to transfer power thereto, for example as described above or in the appropriate standard.

It will be appreciated that according to any one of the above embodiments, the wireless power outlet 100 is configured, after a possible secondary unit 200 has been identified on its surface 160, to initially emit digital pings which are configured to engage, and avoid causing damage to, a secondary unit designed to operate at relatively low power levels (such as those defined in the WPC standard), and only after such secondary units have not been identified by digital pings, to emit digital pings which are configured to engage a secondary unit designed to operate at relatively higher power level (such as those defined in the PMA standard).

According to a further embodiment, the wireless power outlet 100, after the detection (e.g., by an analog ping), attempts to determine the impedance of the secondary unit 200. This may be accomplished by emitting a pulse or series of pulses, which may be low-power, to the secondary unit 200, which results in a current in the primary inductive coil 110. It is well-known in the art that such a current decays in a known way depending on the impedance of the secondary unit 200. Thus, the impedance of the secondary unit 200 can be determined based on the behavior of the current in the primary inductive coil 110.

The wireless power outlet 100 is thus configured to indirectly measure the impedance of the secondary unit 200 by monitoring the current in the primary inductive coil 110 with respect to time. The wireless power outlet 100 is configured to subsequently identify the type of secondary unit 200 by matching the measured impedance with known values of impedances of secondary units, for example according to different standards for inductive receivers (i.e., secondary units), such as the WPC, PMA, and A4WP standards.

The wireless power outlet 100 is further configured to transfer power in accordance with the secondary unit 200 identified. The transfer may include all phases defined in the respective standard of the identified secondary unit 200. Alternatively, one or more phases, such as digital ping, identification, and/or configuration, may be skipped before power is actually transferred.

It will be appreciated that the wireless power outlet 100 may be configured to selectively operate according to one or more of the embodiments described herein, without departing from the scope of the presently disclosed subject matter, mutatis mutandis.

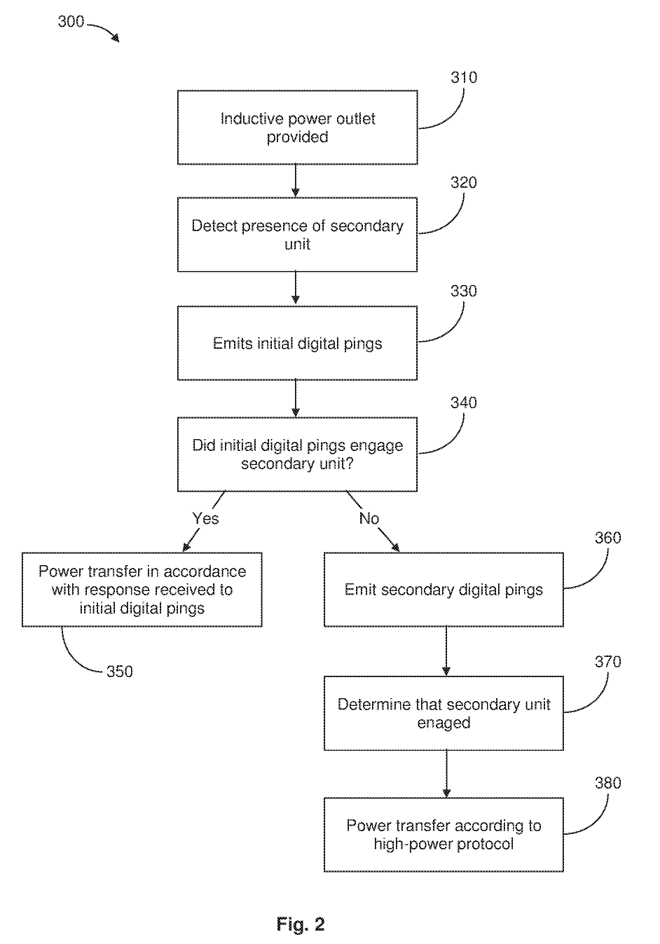

As illustrated in FIG. 2, one example of a method 300 of transferring power inductively is provided. The method 300 may be performed by a wireless power outlet 100 as described above with reference to FIG. 1.

In step 310, a wireless power outlet is provided. The wireless power outlet may be in accordance with the description provided above with reference to FIG. 1, or it may be provided according to any other suitable design.

In step 320, the wireless power outlet detects the presence of a secondary unit, which is configured to form an inductive couple with the wireless power outlet for transfer of power thereto. The detection may take place by an analog ping, or by any other suitable manner.

In step 330, the wireless power outlet emits a predetermined number of initial digital pings. The initial digital pings are in accordance with a low-power wireless transfer protocol, for example as defined in the WPC standard. The initial digital pings may have the same frequency, e.g., about 175 kHz, or have different frequencies, for example one or more of 142 kHz, 140 kHz, 130 kHz, 111 kHz, and 110 kHz. The voltages of the initial digital pings may range between 4V and 6V.

In step 340, the wireless power outlet determines whether or not the initial digital pings engaged the secondary unit, i.e., if it received a response therefrom, for example which meets the definition defined in the WPC standard.

If the wireless power outlet determines in step 340 that one or more of the initial digital pings engaged the secondary unit, the method proceeds to step 350, in which the wireless power outlet transfers power in accordance with the response to the initial digital ping received by the wireless power outlet, for example as defined in the WPC standard.

If the wireless power outlet determines in step 340 that none of the initial digital pings engaged the secondary unit, the method proceeds to step 360, in which the wireless power outlet emits a predetermined number of secondary digital pings. The secondary digital pings are in accordance with a higher-power (i.e., more energetic than that of the initial digital pings) wireless transfer protocol, for example as defined in the PMA standard. The secondary digital pings may have a frequency of about 110 kHz, and/or may range between 8V and 10V.

In step 370, the wireless power outlet determines whether or not the secondary digital pings engaged the secondary unit, i.e., if it received a response therefrom, for example which meets the definition defined in the PMA standard.

If the wireless power outlet determines that the secondary digital pings engaged the secondary unit, the method proceeds to step 380, in which the wireless power outlet transfers power according to a higher-power transfer protocol, for example as defined in the PMA standard.

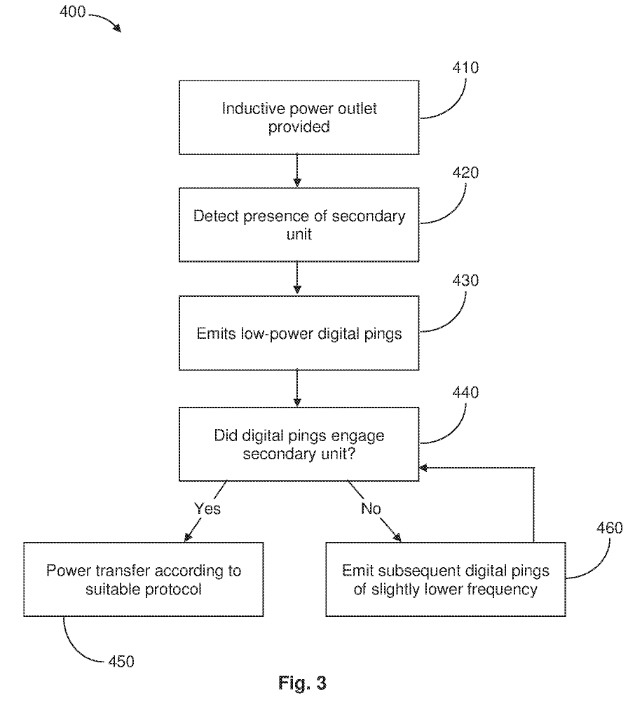

As illustrated in FIG. 3, another example of a method 400 of transferring power inductively is provided. The method 400 may be performed by a wireless power outlet 100 as described above with reference to FIG. 1.

In step 410, a wireless power outlet is provided. The wireless power outlet may be in accordance with the description provided above with reference to FIG. 1, or it may be provided according to any other suitable design.

In step 420, the wireless power outlet detects the presence of a secondary unit, which is configured to form an inductive couple with the wireless power outlet for transfer of power thereto. The detection may take place by an analog ping, or by any other suitable manner.

In step 430, the wireless power outlet emits one or more low-energy digital pings.

In step 440, the wireless power outlet determines whether or not the digital pings engaged the secondary unit, i.e., if it received a response therefrom, for example which meets the definition defined in the WPC standard.

If the wireless power outlet determines in step 440 that one or more of the digital pings engaged the secondary unit, the method proceeds to step 450, in which the wireless power outlet transfers power according to a suitable transfer protocol, for example as defined in the WPC standard.

If the wireless power outlet determines in step 440 that none of the digital pings engaged the secondary unit, the method proceeds to step 460, in which the wireless power outlet emits one or more subsequent digital pings of a slightly lower frequency, which is associated with a higher energy level. This may occur, for example, when the frequency is above the self-resonant frequency of an inductive couple formed between the wireless power outlet and secondary unit.

The method then reverts to step 440, in which the wireless power outlet determines if the subsequent digital ping engaged the secondary unit, i.e., if it received a response therefrom, for example which meets the definition defined in the WPC or the PMA standard.

If the wireless power outlet determines in step 440 that one or more of the digital pings engaged the secondary unit, the method proceeds to step 450, in which the wireless power outlet transfers power according to a suitable transfer protocol, for example as defined in the WPC or PMA standard, in accordance with the parameters of the digital ping which engaged the secondary unit.

If the wireless power outlet determines in step 440 that none of the subsequent digital pings engaged the secondary unit, the method proceeds to step 460, until a digital ping engages the secondary unit.

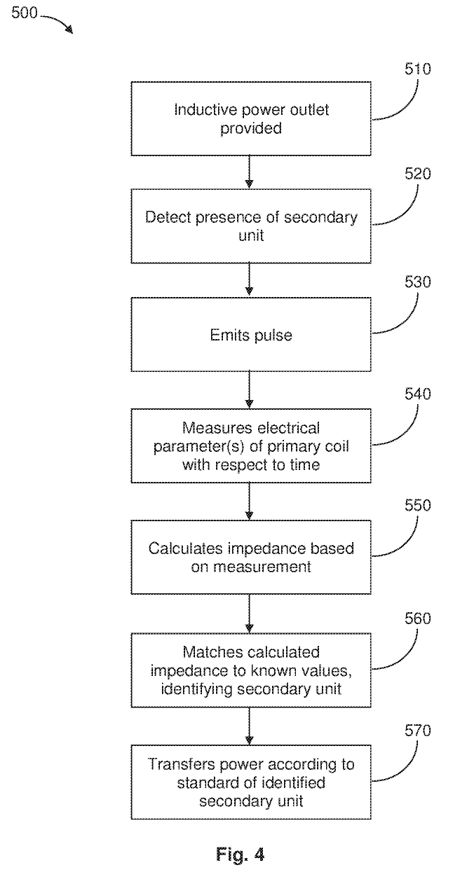

As illustrated in FIG. 4, a further example of a method 500 of transferring power inductively is provided. The method 500 may be performed by a wireless power outlet 100 as described above with reference to FIG. 1.

In step 510, a wireless power outlet is provided. The wireless power outlet may be in accordance with the description provided above with reference to FIG. 1, or it may be provided according to any other suitable design. The wireless power outlet may be preloaded with data pertaining to the specifications of secondary units according to different standards, for example the WPC and/or PMA standards, or may be configured to request and obtain relevant data.

In step 520, the wireless power outlet detects the presence of a secondary unit, which is configured to form an inductive couple with the wireless power outlet for transfer of power thereto. The detection may take place by an analog ping, or by any other suitable manner.

In step 530, the wireless power outlet emits a pulse (or a series of pulses), which may be low-powered, thereby inducing a current in a secondary inductive coil of the secondary unit.

In step 540, the wireless power outlet measures one or more electrical parameters of the primary inductive coil, resulting from pulses, compared to time. For example, it may measure, after a predetermined time interval, the one or more of the amplitude of voltage and amplitude of current. Such a measurement includes measuring indirectly, i.e., measuring the time necessary for one or more electrical parameters to decay to a predetermined level.

In step 550, the wireless power outlet, based on the measurement, calculates the impedance of the secondary unit.

In step 560, the wireless power outlet matches the calculated impedance to known values of impedances of secondary units, thereby identifying the secondary unit.

In step 570, the inductive outlet transfers power to the secondary unit, in accordance with a standard associated with the identified secondary unit.

Those skilled in the art to which this invention pertains will readily appreciate that numerous changes, variations and modifications can be made without departing from the scope of the invention mutatis mutandis.

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as computing unit, network, display, memory, server and the like are intended to include all such new technologies a priori.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the composition or method.

As used herein, the singular form “a”, “an” and “the” may include plural references unless the context clearly dictates otherwise. For example, the term “a compound” or “at least one compound” may include a plurality of compounds, including mixtures thereof.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the disclosure.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

1-13. (canceled)

14. A method of transferring power inductively, the method comprising:
providing a wireless power outlet comprising a primary inductive coil connected to a power source via a driver;
providing a secondary unit configured and disposed to form an inductive couple with said wireless power outlet for power transfer;
emitting, by said wireless power outlet, one or more pulses;
measuring one or more electrical parameters of the primary inductive coil, resulting from said pulses, compared to time;
calculating, based on the measuring, an impedance associated with the secondary unit;
matching, by the wireless power outlet, the calculated impedance to known values of impedances of secondary units, thereby identifying the secondary unit; and
transferring power from the wireless power outlet to the secondary unit, in accordance with a standard associated with the identified secondary unit.

15. The method according to claim 14, wherein said pulses are low powered.

16. The method according to claim 14, wherein said wireless power outlet is preloaded with data pertaining to specifications of secondary units according to two or more standards.

17. The method according to claim 16, wherein said standards comprise one or both of a first standard and a second standard.

18. The method according to claim 14, wherein said wireless power outlet is configured to request and obtain data pertaining to specifications of the secondary unit according to two or more standards.

19. The method according to claim 14, further comprising, prior to the emitting, detecting, by said wireless power outlet, a possible presence of the secondary unit.

20. The method according to claim 19, wherein the detecting comprises emitting, by the wireless power outlet, an analog ping.

21. The method according to claim 14, wherein said electrical parameters comprise one or more selected from the group consisting of amplitude of voltage, amplitude of current, and decay coefficient.

22-34. (canceled)

35. A wireless power outlet comprising a primary inductive coil connected to a power source via a driver, and being configured to transfer power inductively to a secondary unit by:
emitting one or more pulses;
measuring one or more electrical parameters of the primary inductive coil, resulting from said pulses, compared to time;
calculating, based on the measuring, an impedance associated with the secondary unit;
matching the calculated impedance to known values of impedances of secondary units, thereby identifying the secondary unit; and
transferring power to the secondary unit, in accordance with a standard associated with the identified secondary unit.

36. The wireless power outlet according to claim 35, wherein said pulse is low powered.

37. The wireless power outlet according to claim 35, being preloaded with data pertaining to specifications of secondary units according to two or more standards.

38. The wireless power outlet according to claim 37, wherein said standards comprise one or both of a first standard and a second standard.

39. The wireless power outlet according to claim 35, being configured to request and obtain data pertaining to specifications of secondary unit according to two or more standards.

40. The wireless power outlet according to claim 35, being configured to detect, prior to the emitting, a possible presence of the secondary unit.

41. The wireless power outlet according to claim 40, wherein the detecting comprises emitting an analog ping.

42. The wireless power outlet according to claim 35, wherein said electrical parameters comprise one or more selected from the group consisting of amplitude of voltage and amplitude of current.
